(19) United States
(12) Patent Application Publication
(10) Pub. No.: US 2015/0066828 A1
(43) Pub. Date: Mar. 5, 2015

(54) CORRECTING INCONSISTENCIES IN SPATIO-TEMPORAL PREDICTION SYSTEM

(71) Applicant: PUBLIC ENGINES, INC., Draper, UT (US)

(72) Inventor: Praneeth Vepakomma, South Jordan, UT (US)

(21) Appl. No.: 14/470,695

(22) Filed: Aug. 27, 2014

Related U.S. Application Data
(60) Provisional application No. 61/870,707, filed on Aug. 27, 2013.

(51) Int. Cl. G06N 7/00

(52) U.S. Cl. CPC G06N 7/005
USPC 706/46

(57) ABSTRACT

An apparatus, method, and computer program product are disclosed for correcting inconsistencies in a spatio-temporal prediction system. A data module receives event-prediction data comprising a plurality of prediction probabilities. The plurality of prediction probabilities includes one or more ordering inconsistencies. A ranking module calculates one or more event-prediction rankings based on the event-prediction data while adjusting for the one or more ordering inconsistencies. A probability-ordering module orders the prediction probabilities based on the one or more event-prediction rankings.

### CROSS-REFERENCES TO RELATED APPLICATIONS

This application claims the benefit of U.S. Provisional Patent Application No. 61/870,707 entitled “CORRECTING INCONSISTENCIES IN A SPATIO-TEMPORAL PREDICTION SYSTEM” and filed on Aug. 27, 2013, for Praneeth Vepakomma, which is incorporated herein by reference.

### FIELD

This invention relates to predicting future events and more particularly relates to predicting future crime events based on historical crime data.

### BACKGROUND

Predicting future events based on historical data may help decision makers determine where to focus their time, resources, attention, etc. In certain industries, predicting future events may be more important than saving time or resources. For example, in the law enforcement industry, being able to predict where certain crimes are likely to occur may allow law enforcement agencies to focus their time and resources on specific areas to prevent crimes, and any ensuing dangers, from occurring. The historical data, however, may contain several inconsistencies, especially if the data is manually entered. In order to make accurate predictions, these inconsistencies in the historical data may need to be accounted for and/or corrected.

### BRIEF SUMMARY

An apparatus for correcting inconsistencies in a spatio-temporal prediction system is disclosed. A method and computer program product also perform the functions of the apparatus. In one embodiment, an apparatus includes a data module configured to receive event-prediction data comprising a plurality of prediction probabilities. In certain embodiments, the plurality of prediction probabilities comprises one or more ordering inconsistencies. In a further embodiment, the apparatus includes a ranking module configured to calculate one or more event-prediction rankings based on the event-prediction data while adjusting for the one or more ordering inconsistencies. The apparatus, in some embodiments, includes a probability-ordering module configured to order the prediction probabilities based on the one or more event-prediction rankings.

In one embodiment, the apparatus includes a map module configured to present a map of an area associated with the event-prediction probabilities. In certain embodiments, the area presented on the map is associated with one or more crimes. The event-prediction probabilities may be derived from spatio-temporal data associated with the one or more crimes. In certain embodiments, the apparatus includes an overlay module configured to overlay one or more hotspots on a map. The one or more hotspots may indicate an area on the map that has a prediction probability above a predetermined threshold.

In some embodiments, the overlay module further assigns a rank to the one or more hotspots according to the order of the prediction probabilities determined by the probability-ordering module. In one embodiment, the one or more hotspots are associated with one or more selected crimes. The one or more hotspots may represent a likelihood of a near-repeat of a selected crime occurring in an area of the map associated with the hotspot.

In some embodiments, the event-prediction probability data is derived from spatio-temporal data comprising one or more of a time and a location. In a further embodiment, the spatio-temporal data comprises crime data, which may include a time of a crime and a location of a crime. In one embodiment, the plurality of prediction probabilities comprise real numbers that are arranged in a real matrix. In some embodiments, the real matrix includes an asymmetric matrix, a symmetric matrix, or a skew symmetric matrix. In a further embodiment, the ranking module calculates the one or more event-prediction rankings using a discrete Helmholtz-Hodge decomposition.

A method is disclosed that includes receiving event-prediction data comprising a plurality of prediction probabilities. In one embodiment, the plurality of prediction probabilities comprising one or more ordering inconsistencies. In certain embodiments, the method includes calculating one or more event-prediction rankings based on the event-prediction data while adjusting for the one or more ordering inconsistencies. In a further embodiment, the method includes ordering the prediction probabilities based on the one or more event-prediction rankings.

The method, in some embodiments, further includes presenting a map of an area associated with the event-prediction probabilities. In one embodiment, the area presented on the map is associated with one or more crimes. The event-prediction probabilities may be derived from spatio-temporal data associated with the one or more crimes. In some embodiment, the method includes overlaying one or more hotspots on a map. In one embodiment, the one or more hotspots indicate an area on the map that has a prediction probability above a predetermined threshold.

In one embodiment, the method further includes assigning a rank to the one or more hotspots according to the order of the prediction probabilities determined by the probability-ordering module. In a further embodiment, the one or more hotspots are associated with one or more selected crimes. In some embodiments, the one or more hotspots represent a likelihood of a near-repeat of a selected crime occurring in an area of the map associated with the hotspot.

In certain embodiments, the event-prediction probability data is derived from spatio-temporal data, which may include one or more of a time and a location. In some embodiments, the spatio-temporal data comprises crime data, which may include a time of a crime and a location of a crime. In a further embodiment, the plurality of prediction probabilities comprise real numbers that are arranged in a real matrix, the real matrix comprising one of an asymmetric matrix, a symmetric matrix, and a skew symmetric matrix.

In one embodiment, a program product is disclosed that includes a computer readable storage medium that stores code executable by a processor. In one embodiment, the executable code comprises code to perform receiving event-prediction data comprising a plurality of prediction probabilities. In certain embodiments, the plurality of prediction probabilities comprise one or more ordering inconsistencies. In one embodiment, the executable code includes code to perform calculating one or more event-prediction rankings based on the event-prediction data while adjusting for the one or more ordering inconsistencies. In a further embodiment, the executable code includes code to perform ordering the prediction probabilities based on the one or more event-prediction rankings.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a schematic block diagram illustrating one embodiment of a system for correcting inconsistencies in a spatio-temporal prediction system;

FIG. 2 is a schematic block diagram illustrating one embodiment of a spatio-temporal prediction system;

FIG. 3A is a schematic block diagram illustrating one embodiment of an apparatus for correcting inconsistencies in a spatio-temporal prediction system;

FIG. 3B is a schematic block diagram illustrating one embodiment of another apparatus for correcting inconsistencies in a spatio-temporal prediction system;

FIG. 4 is a schematic flow chart diagram illustrating one embodiment of a method for correcting inconsistencies in a spatio-temporal prediction system;

FIG. 5 is a schematic flow chart diagram illustrating one embodiment of another method for correcting inconsistencies in a spatio-temporal prediction system; and

FIG. 6 illustrates one embodiment of crime-prediction map.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

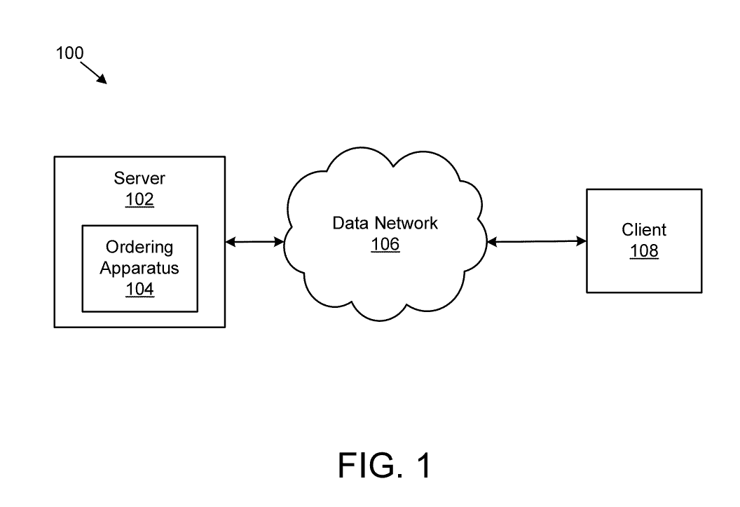

FIG. 1 depicts one embodiment of a system 100 for correcting inconsistencies in a spatio-temporal prediction system. The system 100, in one embodiment, includes a server 102, an ordering apparatus 104, a data network 106, and a client 108, which are described in more detail below.

In one embodiment, the system 100 includes a server 102. The server 102, in some embodiments, includes a main frame computer, a desktop computer, a laptop computer, a cloud server, and/or the like. In certain embodiments, the server 102 includes at least a portion of the ordering apparatus 104. In another embodiment, the client 108 is communicatively coupled to the server 102 through the data network 106. The client 108, in some embodiments, obtains at least a portion of its data from the server 102. The server, in certain embodiments, includes a storage device, such as a database, configured to store data associated with an event-prediction system. In one embodiment, the storage device stores crime-related data, which may include a crime, a timestamp, a location (e.g., an address, longitude/latitude coordinates, or the like), and/or the like.

In another embodiment, the system 100 includes an ordering apparatus 104. As described below in more detail, in one embodiment, the ordering apparatus 104 receives event-prediction data. As used herein, event-prediction data may comprise data indicating the likelihood of some future event. In some embodiments, the event-prediction data comprises event-prediction probabilities that describe the likelihood of an event occurring in the future. In some embodiments, the event-prediction data includes a real matrix of prediction probabilities that include one or more ordering inconsistencies. In another embodiment, the ordering apparatus 104 calculates one or more event-prediction rankings based on the event-prediction probability data while adjusting for the one or more ordering inconsistencies. In one embodiment, the ordering apparatus 104 orders the event-prediction probabilities based on the one or more calculated event-prediction rankings.

In certain embodiments, the system 100 includes a data network 106. The data network 106, in certain embodiments, is a digital communication network 106 that transmits digital communications related to correcting inconsistencies in a spatio-temporal prediction system. The digital communication network 106 may include a wireless network, such as a wireless telephone network, a local wireless network, such as a Wi-Fi network, a Bluetooth® network, and the like. The digital communication network 106 may include a wide area network (“WAN”), a storage area network (“SAN”), a local area network (“LAN”), an optical fiber network, the internet, or other digital communication network known in the art. The digital communication network 106 may include two or more networks. The digital communication network 106 may include one or more servers, routers, switches, and/or other networking equipment. The digital communication network 106 may also include computer readable storage media, such as a hard disk drive, an optical drive, non-volatile memory, random access memory (“RAM”), or the like.

In another embodiment, the system 100 includes a client 108. In one embodiment, the client 108 includes a desktop computer, a laptop computer, a mobile device, a smart phone, a tablet computer, a smart TV, and/or the like. In certain embodiments, the client 108 includes an electronic display configured to present a prediction interface to a user. In some embodiments, the prediction interface includes a map and a crime-prediction overlay such that the user visually sees one or more predicted crime events within a geographic region.

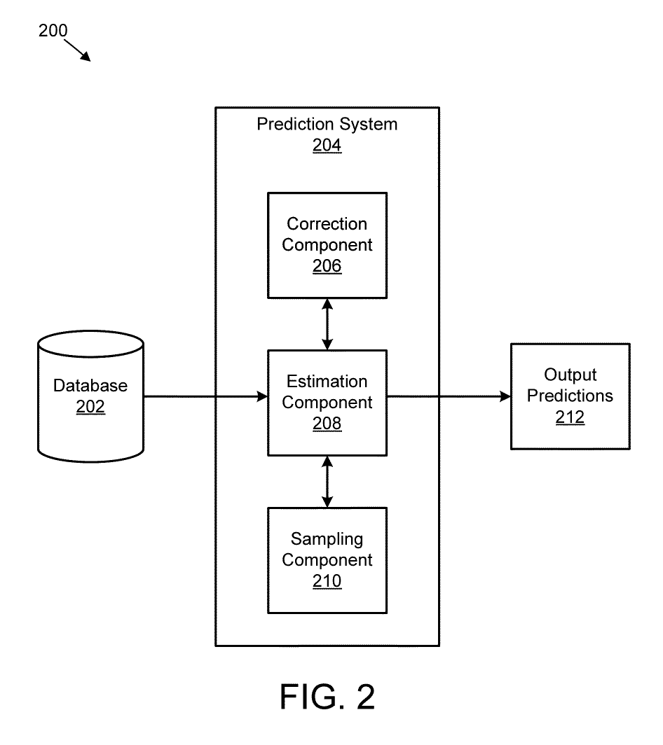

FIG. 2 depicts one embodiment of a spatio-temporal prediction system 200. In certain embodiments, the system 200 includes a database 202, a prediction system 204 and one or more output predictions 212. In certain embodiments, the prediction system 204 includes a correction component 206, an estimation component 208, and a sampling component 210. In certain embodiments, the database 202 and the prediction system 204 are located on the server 102 and include at least a portion of the ordering apparatus 104.

In one embodiment, the database 202 includes raw spatio-temporal data. In certain embodiments, the raw spatio-temporal data includes crime-event data, such as the type of crime, the location of the crime (e.g., an address, a longitude/latitude pair, or the like), the time of the crime, and/or the like. The raw spatio-temporal data, in one embodiment, is processed by the prediction system 204 to produce one or more output predictions 212, such as near-repeat crime predictions based on raw crime-event data. Near-repeat crime predictions, as used herein, describe the likelihood of a crime occurring based on similar reported crime incidents within a specified area and/or time. The raw crime-event data, in certain embodiments, is manually entered by law enforcement personnel, which may make it difficult to rank the data. For example, crime-related data may be ranked in terms of priority, best-to-worst, or the like, in order to determine which areas are likely to be affected by future crimes. By manually ranking crime-event data, due to its subjective nature, one or more ordering inconsistencies in the data may be generated. Thus, the correction component 206 of the prediction system 204, in certain embodiments as described below, corrects for these inconsistencies such that more accurate rankings of crime data are available for law enforcement personnel.

In certain embodiments, the database 202 provides raw spatio-temporal data to the estimation component 208. The estimation component 208, in certain embodiments, processes the raw spatio-temporal data and converts the raw spatio-temporal data into one or more event-prediction probabilities. In some embodiments, the estimation component 208 iteratively estimates a probability matrix with probabilities of repeat events in the spatial proximity and with a temporal shift of the down-sampled input spatio-temporal data. In certain embodiments, the matrix comprises an asymmetric matrix, a symmetric matrix, a skew symmetric matrix, and/or any matrix containing real numbers.

In certain embodiments, the estimation component 208 sends event-prediction probabilities to a sampling component 210 for further processing. The sampling component 210, in one embodiment, produces resamples, as well as necessary up- and down-samples, based on iterative rankings and asymmetric probability estimates. After processing the event-prediction probabilities, the sampling component 210 sends the processed data to the estimation component 208.

The estimation component 208, in another embodiment, sends the matrix of event-prediction probabilities to the correction component 206, which iteratively removes intransitivity and inconsistency relations from asymmetric matrices of probabilities generated by the estimation 208 and the sampling 210 components. In certain embodiments, the correction component 206 removes the inconsistencies at each iteration and produces global rankings of spatio-temporal data. For example, one set of data points a, b, c may be ranked a<b<c, where a has a higher rank than c, by one user while the same set of data points a, b, c may be ranked b<c<a, where b has a higher rank than a, by a different user. The correction component 206, in certain embodiments, generates an overall ranking of the values within the data sets while adjusting for the inconsistencies in the rankings. The operations of the correction component 206 are discussed in more detail below.

The correction component 206, in another embodiment, sends the generated rankings of the event-prediction probabilities back to the estimation component 208, which incorporates the rankings into the current event-prediction data and begins a new iteration. The estimation component 208, in certain embodiments, outputs 212 the event-prediction matrix. The event-prediction matrix may be outputted in response to the number of iterations reaching a threshold value, a metric being reached, one or more values converging to a predetermined value, and/or the like. The output prediction matrix, in certain embodiments, is a square matrix that has the same number of rows and columns where the diagonal values contain the event-prediction probabilities of interest. In some embodiments, the event-prediction matrix contains predictive crime-related probabilities and the diagonal of the matrix describes the predictive probabilities of a specific crime being committed at a specific location and time. In some embodiments, lower probabilities (e.g., probabilities close to zero) indicate a higher likelihood of a near-repeat event.

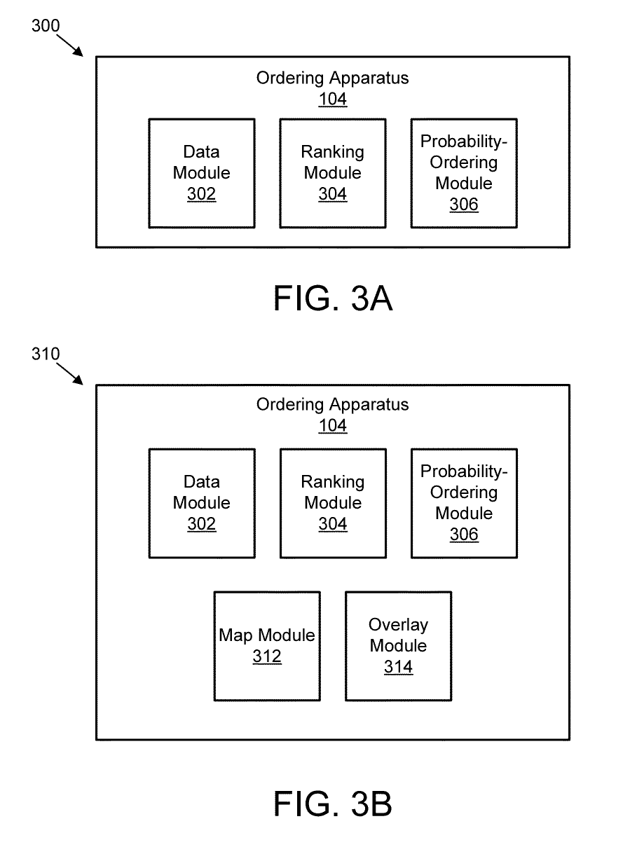

FIG. 3A depicts one embodiment of an apparatus 300 for correcting inconsistencies in a spatio-temporal prediction system. In one embodiment, the apparatus 300 includes an ordering apparatus 104. The ordering apparatus 104, in certain embodiments, includes a data module 302, a ranking module 304, and a probability-ordering module 306, which are described in more detail below. In certain embodiments, the ordering apparatus 104 is located on the correction component 206 of the predictive system 204 and performs at least a portion of the operations associated with the correction component 206.

In certain embodiments, the modules 302-306 perform the operations of the correction component 206, which includes formulating discrete Helmholtz-Hodge decomposition (also known as discrete Hodge-Helmholtz decomposition or discrete Helmholtz decomposition) on the estimates of the probabilities obtained from a bootstrapped point process model. In certain embodiments, the probabilities are for a class of symmetric matrices. In a further embodiment, the correction component 206 performs discrete Helmholtz-Hodge decomposition on asymmetric class of probabilistic matrices by producing an equivalent class of matrices.

In one embodiment, the ordering apparatus 104 includes a data module 302 configured to receive event-prediction data, such as data related to crime prediction events. In some embodiments, the event-prediction data includes a real matrix of prediction probabilities, where each value in the matrix has a value between zero and one, inclusive. In some embodiments, the real matrix of prediction probabilities includes one or more ordering inconsistencies. In certain embodiments, the real matrix is an asymmetric matrix P created by an iteration of processing by the estimation component 208 and the sampling component 210. In a further embodiment, the real matrix includes a symmetric matrix, a skew-symmetric matrix, or any matrix containing real numbers.

In another embodiment, the ordering apparatus 104 includes a ranking module 304 configured to calculate one or more event-prediction rankings based on the event-prediction probability data while adjusting for the one or more ordering inconsistencies. In one embodiment, in order to generate the one or more event-prediction rankings, the ranking module 304 performs one or more mathematical operations on the matrix P received by the data module 302, as described below.

In one embodiment, the ranking module 304 receives the matrix P received by the data module 302. The matrix P, in another embodiment, is an asymmetric matrix populated with a plurality of real numbers. In a further embodiment, the matrix P is a symmetric matrix, skew symmetric matrix, and/or the like.

In one embodiment where the matrix P is any real matrix, such as an asymmetric real matrix, the ranking module 304 represents P as the sum of a symmetric matrix A and a skew-symmetric matrix B, respectively: P=A+B where

$$A = \frac{P + {P}^{T}}{2} and B = \frac{P - {P}^{T}}{2} .$$

In certain embodiments, the ranking module 304 processes any real matrix P, and is not limited solely to symmetric or skew-symmetric matrices as inputs, as in traditional ranking and ordering algorithms.

In a further embodiment, the ranking module 304, for each dimension d={2, 3, . . . k}, where k is a predetermined threshold value, nonlinearly embeds the off-diagonal part of the symmetric matrix A, which contains the ordering inconsistencies, into dimensions d={2, 3, . . . k} considering it to be a similarity matrix that produces a set of matrices e={E₂, E₃, . . . Eₖ}.

The ranking module 304, in another embodiment, computes one or more distance matrices d={DP₂, DP₃, . . . DPₖ}, where each distance matrix DP contains the distances, taken pairwise, between a set of points. In one embodiment, distance matrix DPₙ is formed such that the upper-diagonal is the upper-diagonal of P and the lower-diagonal is the transpose of the upper-diagonal of P. In certain embodiments, the ranking module 304 calculates the distance matrices DP based on the matrices within the set e={E₂, E₃, . . . Eₖ}, such as calculating the distances between the embed matrices e={E₂, E₃, . . . Eₖ}.

In a further embodiment, the ranking module 304 calculates k weight matrices Wᵢⱼ^{k}=Σⱼ^{k}[log(DPᵢⱼ^{k})− log(DPⱼᵢ^{k})], where DP is the embedded distance matrix for each dimension d={2, 3, . . . k}. The ranking module 304, in another embodiment, computes the discrete Helmholtz-Hodge decomposition of each weight matrix W. In one embodiment, the ranking module 304 computes the discrete Helmholtz-Hodge decomposition of skew-symmetric matrix B. The output of the discrete Helmholtz-Hodge decomposition of each weight matrix W and the skew-symmetric matrix B comprises 1 to k−1 orderings/rankings. In certain embodiments, the orderings comprise a plurality of column vectors (1 . . . k−1 vectors), where each column vector comprises orderings or rearranged indices. In a further embodiment, the ranking module 304 calculates the average of all the orderings produced by using symmetric matrix A and skew-symmetric matrix B to generate R1, which is a ranking of the calculated averages of all the ordering vectors.

In another embodiment, the ranking module 304 produces a second ranking of orderings, R2. In one embodiment, the ranking module 304 calculates another set of k weight matrices Z, such that Zᵢⱼ^{k}=Σᵢ^{k}[log(DPᵢⱼ^{k})− log(DPⱼᵢ^{k})], where DP is the embedded distance matrix of the set d={DP₂, DP₃, . . . DPₖ} in each dimension d={2, 3, . . . k}. In one embodiment, distance matrix DPₙ is formed such that the upper-diagonal is the upper-diagonal of P and the lower-diagonal is the transpose of the upper-diagonal of P. The ranking module 304, in another embodiment, performs a discrete Helmholtz-Hodge decomposition of each weight matrix Z. The output of the discrete Helmholtz-Hodge decomposition comprises 1 to k−1 orderings/rankings. In certain embodiments, the orderings comprise a plurality of column vectors (1 . . . k−1 vectors), where each column vector comprises orderings or rearranged indices. In a further embodiment, the ranking module 304 calculates the average of all the orderings produced by using symmetric matrices A and B to generate R2, which is a ranking of the calculated averages of all the ordering vectors.

The ranking module 304, in one embodiment, computes a discrete Helmholtz-Hodge rank on the total (2 k+4) rankings from R1 and R2. The ranking module 304, in another embodiment, includes the top t points from the average k+1 ranking scores in the next sub-sample as well as bootstrap sample, which is sent to the estimation component 208 and the sampling component 210 to be processed in a new iteration.

The ordering apparatus 104, in another embodiment, includes a probability-ordering module 306 configured to order the event-prediction probabilities based on the one or more calculated event-prediction rankings, e.g., by ordering the event-prediction probabilities in descending order according to their associated event-prediction rankings. In this manner, the ordering apparatus 104 is able to rank prediction data that includes one or more inconsistencies by adjusting for the inconsistencies through an iterative process. In certain embodiments where the raw spatio-temporal data comprises crime data, the ordering apparatus 104 is able to rank different crime areas based on a predictive probability of a near repeat. The raw spatio-temporal data may have one or more ordering inconsistencies (e.g., it may be difficult to rank one location/time over another location/time), which are accounted for by the correction component 206 such that the raw spatio-temporal data may be assigned a ranking along with a predictive probability of a near repeat.

FIG. 3B depicts another embodiment of an apparatus 310 for correcting inconsistencies in a spatio-temporal prediction system. In one embodiment, the apparatus 310 includes an ordering apparatus 104. The ordering apparatus 104, in certain embodiments, includes a data module 302, a ranking module 304, and a probability-ordering module 306, which are substantially similar to the data module 302, ranking module 304, and probability-ordering module 306 described with reference to FIG. 3A. In a further embodiment, the ordering apparatus includes a map module 312 and an overlay module 314, which are described below.

In one embodiment, the ordering apparatus 104 includes a map module 312 configured to display a map of an area related to raw crime data. In one embodiment, the raw crime data includes a crime type, a crime location, such as latitude and longitude, and a crime timestamp. The raw crime data is processed by the prediction system 204, which produces one or more crime-prediction probabilities. The map displayed by the map module 312 is based on selected raw crime data. For example, a law enforcement officer may select a specific crime, e.g., arson, within a selected area, e.g., a five-mile radius, and within a specified time period. The map module 312, in certain embodiments, displays all instances of the selected crime on the map according to the preferences set by the user (e.g., the location and time).

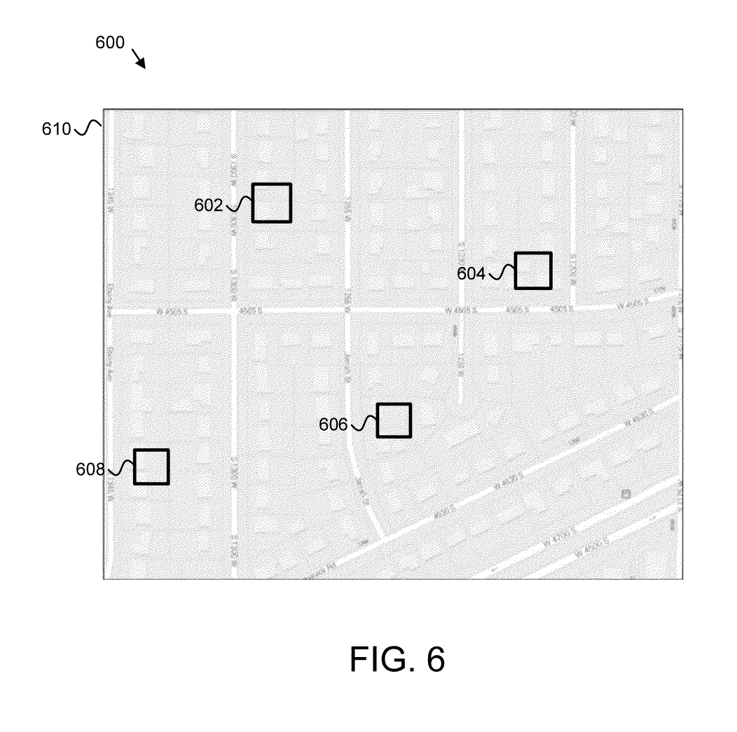

In another embodiment, the ordering apparatus 104 includes an overlay module 314 configured to display one or more hotspots over the mapped area displayed by the map module 312. The one or more hotspots, as shown below with reference to FIG. 6, highlights areas of the map where there is a high-probability of a near-repeat crime occurring. The different hotspot areas, in another embodiment, are ranked according to a priority such that law enforcement personnel can more accurately make decisions regarding where to focus their activities. The hotspots, in another embodiment, are based on the crime-prediction probabilities, which have had any inconsistencies removed by the correction component 206, generated by the prediction system 204.

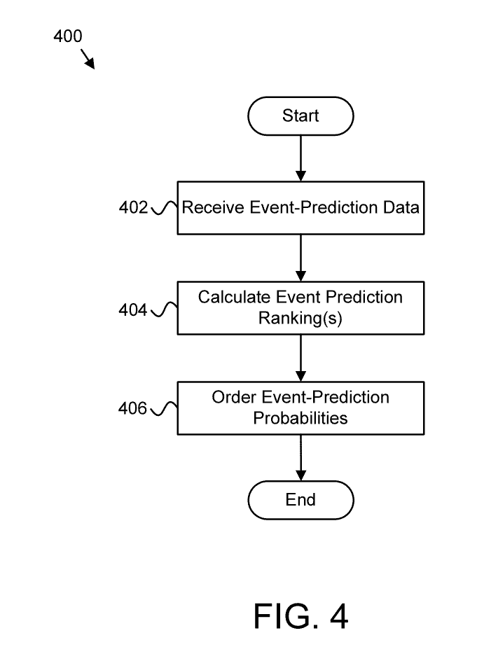

FIG. 4 depicts one embodiment of a method 400 for correcting inconsistencies in a spatio-temporal prediction system. In one embodiment, the method 400 begins and a data module 302 receives 402 event-prediction data. In some embodiments, the event-prediction data comprises a real matrix of prediction probabilities. In another embodiment, the real matrix of prediction probabilities includes one or more ordering inconsistencies.

In another embodiment, a ranking module 304 calculates 404 one or more event-prediction rankings based on the event-prediction probability data while adjusting for the one or more ordering inconsistencies. In another embodiment, a probability-ordering module 306 orders 406 the event-prediction probabilities based on the one or more calculated event-prediction rankings and the method 400 ends.

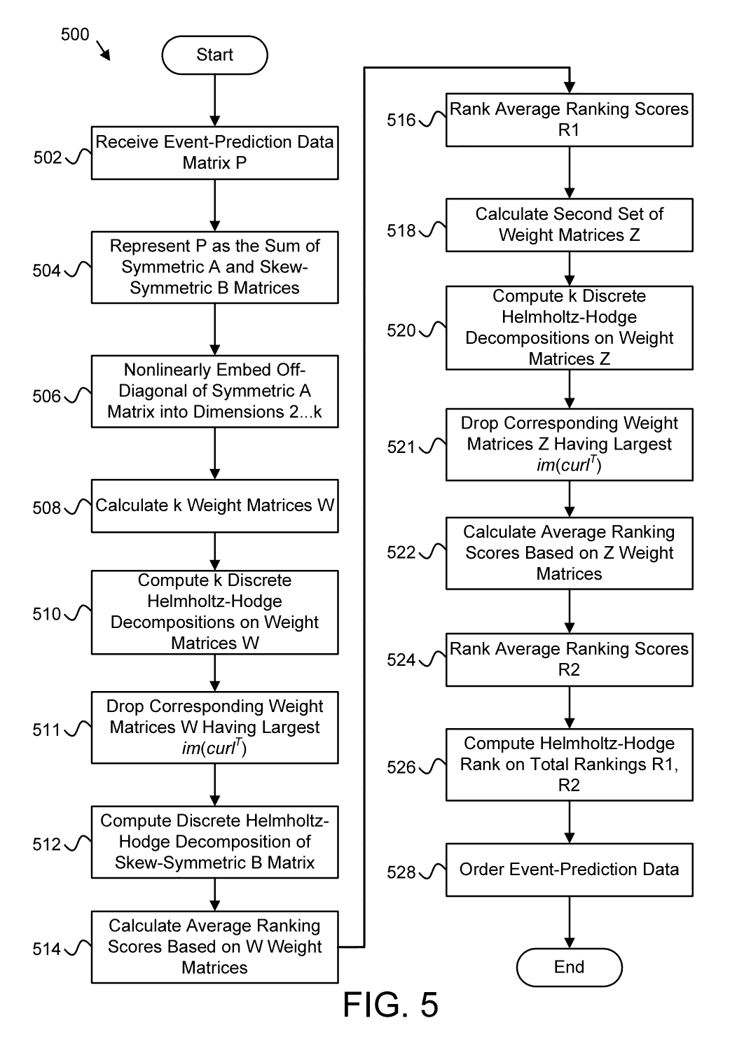

FIG. 5 depicts another embodiment of a method 500 for correcting inconsistencies in a spatio-temporal prediction system. In one embodiment, the method 500 begins and a data module 302 receives 502 event-prediction data. In one embodiment, the event prediction data is any real matrix P comprising one or more probabilities associated with raw crime data, such as a crime type (e.g., larceny, arson, or the like), a crime location, and a crime timestamp. In certain embodiments, the probability matrix P is generated by an estimating component 208 and/or a sampling component 210 processing the raw crime data to derive the one or more probabilities.

In another embodiment, a ranking module 304 calculates event-prediction rankings. In certain embodiments, the event-prediction rankings prioritize crime-related data by probability of near-repeat. In certain embodiments, in order to calculate the event-prediction rankings, the ranking module 304 represents 504 P as the sum of symmetric matrix A and skew-symmetric B, as described above. The ranking module 304, in another embodiment, nonlinearly embeds 506 the off-diagonal part of the symmetric matrix A, which contains the ordering inconsistencies, into dimensions d={2, 3, . . . k}, in order to generate a set of embeddable distance matrices d={DP₂, DP₃, . . . DPₖ}.

In a further embodiment, the ranking module 304 calculates 508 k weight matrices Wᵢⱼ^{k}=Σⱼ^{k}[log(DPᵢⱼ^{k})− log(DPⱼᵢ^{k})], where DP is the embedded distance matrix of the set d={DP₂, DP₃, . . . DPₖ} in each dimension d={2, 3, . . . k}. The ranking module 304 calculates k weight matrices such that Wᵢⱼ^{k} comprises the number of points within k nearest neighborhood of j and the number of points within k nearest neighborhood of i. In another embodiment, distance matrix DPₙ is formed such that the upper-diagonal is the upper-diagonal of P and the lower-diagonal is the transpose of the upper-diagonal of P. In one embodiment, the ranking module 304 computes 510 k discrete Helmholtz-Hodge decompositions on skew-symmetric portions of k weight matrices. In certain embodiments, the ranking module 304 drops 511 corresponding weight matrices that result in the largest im(curl^{T}) matrix, where im is an image matrix and curl^{T} is the transpose of the curl operation performed on the k weight matrices. In some embodiments, the ranking module computes 512 a discrete Helmholtz-Hodge decomposition on the skew-symmetric matrix B. The ranking module 304, in a further embodiment, calculates 514 the average of the k+1 ranking scores based on weight matrices W and ranks 516 the average ranking scores R1.

In one embodiment, the ranking module 304 calculates 518 a second set of k weight matrices Zᵢⱼ^{k}=Σᵢ^{k}[log(DPᵢⱼ^{k})− log(DPⱼᵢ^{k})], where DP is the embedded distance matrix of the set d={DP₂, DP₃, . . . DPₖ} in each dimension d={2, 3, . . . k}. The ranking module 304 calculates k weight matrices such that Zᵢⱼ^{k} comprises the number of points within k nearest neighborhood of j and the number of points within k nearest neighborhood of i. The ranking module 304, in another embodiment, computes 520 k discrete Helmholtz-Hodge decompositions on skew-symmetric portions of weight matrices Z. In certain embodiments, the ranking module 304 drops 521 corresponding weight matrices Z that result in the largest im(curl^{T}) matrix, where im is an image matrix and curl^{T} is the transpose of the curl operation performed on the weight matrices Z. In some embodiments, the number of weight matrices Z that are dropped is determined beforehand, either algorithmically or manually. In one embodiment, the ranking module 304 calculates 522 the average of the k+1 ranking scores based on weight matrices Z and ranks 524 the average ranking scores R2.

The ranking module 304 in a further embodiment, computes 526 a discrete Helmholtz-Hodge rank on 2 k+4 total rankings (e.g., rankings R1 and R2). The ranking module 304, in another embodiment, includes the top t points from the average k+1 ranking scores in the next sub-sample as well as bootstrap sample, which is sent to the estimation component 208 and the sampling component 210 to be processed in a new iteration. A probability-ordering module 306 orders 528 the event-prediction data and outputs a set of predictions. For example, if the event-prediction data includes crime-related data, the probability-ordering module 306 may output one or more near-repeat predictions, each with an assigned priority based on the output rankings generated by the ranking module 304. And the method 500 ends.

FIG. 6 depicts one embodiment of a crime-prediction map 600 in accordance with the present subject matter. In one embodiment, the map module 312 presents a mapped area 610 and an overlay module 314 presents a crime-prediction overlay over the mapped area 610. The map module 312 configures the mapped area 610, in one embodiment, based on the crime data the user wants to view on the map. In another embodiment, the user selects a specific area to view crime data. For example, a user may specify viewing all larceny-related crimes, within ten miles, that occurred last week.

The overlay presented by the overlay module 314, in certain embodiments, presents one or more crime hotspots 602-608 on the mapped area 610, which describe areas with a prediction probability of near-repeat crimes above a predetermined threshold. For example, the overlay module 314 may display hotspots 602-608 if the prediction probabilities associated with hotspots 602-608 are above 0.3, or the like. Thus, in some embodiments, each hotspot 602-608 represents one or more areas associated with the prediction probabilities.

In some embodiments, the hotspots 602-608 are associated with a specific crime, which may be selected by a user. In certain embodiments, the overlay module 314 assigns the hotspots 602-608 a priority based on the event-prediction data, in particular the event-prediction rankings and/or the order of the prediction probabilities, as calculated by the prediction engine 204. In this manner, law enforcement personnel may be able to target their activities in areas where there is a higher-chance of near-repeat crimes occurring. Users may select a hotspot 602-608, e.g., by hovering over the hotspot 602-608 or touching a hotspot 602-608 on a touch-enabled device, to view additional information about the area of the map 600 associated with the hotspot 602-608, such as neighborhood information, crime statistics, demographics, or the like. In certain embodiments, the overlay module 314 assigns a color, or a different identifying characteristic, to a hotspot 602-608 based on its priority, ranking, or the like.

As described above, the event-prediction data that provides the basis of the hotspots 602-608 may be generated by a prediction system 204 processing raw crime data, such as a crime type, location, timestamp, and/or the like. This data may be manually entered by law enforcement personnel. Trying to rank this data, e.g., from best to worst, may be too subjective, which may create one or more ordering inconsistencies in the data. Thus, the correction component 206 of the prediction system 204, in certain embodiments as described above, corrects for these inconsistencies such that more accurate rankings of crime data is available.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a data module configured to receive event-prediction data comprising a plurality of prediction probabilities, the plurality of prediction probabilities comprising one or more ordering inconsistencies;
a ranking module configured to calculate one or more event-prediction rankings based on the event-prediction data while adjusting for the one or more ordering inconsistencies; and
a probability-ordering module configured to order the prediction probabilities based on the one or more event-prediction rankings.

2. The apparatus of claim 1, further comprising a map module configured to present a map of an area associated with the event-prediction probabilities.

3. The apparatus of claim 2, wherein the area presented on the map is associated with one or more crimes, the event-prediction probabilities being derived from spatio-temporal data associated with the one or more crimes.

4. The apparatus of claim 1, further comprising an overlay module configured to overlay one or more hotspots on a map, the one or more hotspots indicating an area on the map that has a prediction probability above a predetermined threshold.

5. The apparatus of claim 4, wherein the overlay module further assigns a rank to the one or more hotspots according to the order of the prediction probabilities determined by the probability-ordering module.

6. The apparatus of claim 4, wherein the one or more hotspots are associated with one or more selected crimes, the one or more hotspots representing a likelihood of a near-repeat of a selected crime occurring in an area of the map associated with the hotspot.

7. The apparatus of claim 1, wherein the event-prediction probability data is derived from spatio-temporal data, the spatio-temporal data comprising one or more of a time and a location.

8. The apparatus of claim 7, wherein the spatio-temporal data comprises crime data, the crime data comprising a time of a crime and a location of a crime.

9. The apparatus of claim 1, wherein the plurality of prediction probabilities comprise real numbers that are arranged in a real matrix, the real matrix comprising one of an asymmetric matrix, a symmetric matrix, and a skew symmetric matrix.

10. The apparatus of claim 1, wherein the ranking module calculates the one or more event-prediction rankings using a discrete Helmholtz-Hodge decomposition.

11. A method comprising:
receiving event-prediction data comprising a plurality of prediction probabilities, the plurality of prediction probabilities comprising one or more ordering inconsistencies;
calculating one or more event-prediction rankings based on the event-prediction data while adjusting for the one or more ordering inconsistencies; and
ordering the prediction probabilities based on the one or more event-prediction rankings.

12. The method of claim 11, further comprising presenting a map of an area associated with the event-prediction probabilities.

13. The method of claim 12, wherein the area presented on the map is associated with one or more crimes, the event-prediction probabilities being derived from spatio-temporal data associated with the one or more crimes.

14. The method of claim 11, further comprising overlaying one or more hotspots on a map, the one or more hotspots indicating an area on the map that has a prediction probability above a predetermined threshold.

15. The method of claim 14, further comprising assigning a rank to the one or more hotspots according to the order of the prediction probabilities determined by the probability-ordering module.

16. The method of claim 14, wherein the one or more hotspots are associated with one or more selected crimes, the one or more hotspots representing a likelihood of a near-repeat of a selected crime occurring in an area of the map associated with the hotspot.

17. The method of claim 11, wherein the event-prediction probability data is derived from spatio-temporal data, the spatio-temporal data comprising one or more of a time and a location.

18. The method of claim 17, wherein the spatio-temporal data comprises crime data, the crime data comprising a time of a crime and a location of a crime.

19. The method of claim 11, wherein the plurality of prediction probabilities comprise real numbers that are arranged in a real matrix, the real matrix comprising one of an asymmetric matrix, a symmetric matrix, and a skew symmetric matrix.

20. A program product comprising a computer readable storage medium that stores code executable by a processor, the executable code comprising code to perform:
receiving event-prediction data comprising a plurality of prediction probabilities, the plurality of prediction probabilities comprising one or more ordering inconsistencies;
calculating one or more event-prediction rankings based on the event-prediction data while adjusting for the one or more ordering inconsistencies; and
ordering the prediction probabilities based on the one or more event-prediction rankings.
